(19) United States
(12) Patent Application Publication
(10) Pub. No.: US 2006/0061983 A1
(43) Pub. Date: Mar. 23, 2006

(54) Lighting device for housing

(75) Inventors: Hsin-Ying Chen, Taipei (TW); Peng-Hui Chou, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/227,118

(22) Filed: Sep. 16, 2005

(30) Foreign Application Priority Data
Sep. 22, 2004 (TW) 093128780

(51) Int. Cl. F21V 9/16

(52) U.S. Cl. 362/84

(57) ABSTRACT

A lighting device of a housing has a concave portion. The concave portion has a surface and a sidewall. The surface has an opening for a connection port. The lighting device includes a flexible lighting element sited on the sidewall of the concave portion.

### BACKGROUND OF THE INVENTION

1. Field of the Invention

The invention relates to a lighting device and, in particular, to a lighting device for a housing.

2. Related Art

The connection ports and terminals of a computer are usually provided at the back of the computer housing. For saving more space, a user would put a computer under a desk or other places that don't have enough light. Due to insufficient light, it is inconvenient for the user to connect peripheral devices to the computer by using the ports and terminals at the back of the computer housing.

To solve this problem, conventionally the user may use a flashlight as a light source. The disadvantage of using a flashlight is that since the user must use one hand to hold the flashlight, another hand to perform the examination or connection operation, which would be very inconvenient. If the user put the flashlight aside, it would also be inconvenient because the user cannot change the direction of the light during the operation. The user may choose to move the computer to a brighter place to perform the examination or the connection operation. However, the computer may connect to other devices by using short connection wires, it is difficult to move the computer.

Recently some venders developed computers with CCFL (Cold Cathode Fluorescent Lamp) tubes or LEDs (Light Emitting Diode) at the back of the housings. However, the size of a CCFL tube is large comparing to the available space at the back of the computer housing, which makes it difficult to mount a CCFL tube on the computer housing. An LED is smaller than a CCFL tube, but it has a smaller illumination area, and its light is easier to be blocked. Furthermore, a housing with a CCFL or an LED needs a special design, which results in inconvenience while assembling and using, and raises the production cost.

An up-to-date computer housing often has a concave portion with the connection ports and terminals provided therein to prevent the loose of the connection ports and terminals due to accident collisions or impacts. Therefore, how to use the limited space of the concave portion to provide sufficient light to facilitate the connection or examining operation of the user has become an important issue needs to be solved.

### SUMMARY OF THE INVENTION

In view of the above, the invention is to provide a lighting device for a housing to facilitate the connection or examining operation of a user using the limited space of the housing.

To achieve the above-mentioned, the lighting device according to the invention is provided on a housing having a concave portion. The concave portion has a surface and a sidewall, and the surface has an opening for a connection port. The lighting device includes a flexible lighting element sited on the sidewall of the concave portion.

In one embodiment of the invention, the flexible lighting element may be a luminescence sheet or an organic electroluminescent film. The lighting device may include a power module electrically connected with the flexible lighting element, and the power module may be a DC power module or an AC power module. A rectifier may electrically connect the power module with the flexible lighting element and change a power type output of the power module to another power type for lighting the flexible lighting element. A switch may also provided to be electrically connected with the flexible lighting element for switching the flexible lighting element to an on or off status.

Since the flexible lighting element of the lighting device is sited on the sidewall of the concave portion, light is provided from the sidewall, which can reduce the phenomenon of back-lighted and provide better light effect. Furthermore, the shape of the flexible lighting element can be designed according to the shape of the sidewall of the concave portion.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram showing the lighting device according to an embodiment of the invention;

FIG. 2 is another schematic diagram showing the lighting device according to an embodiment of the invention;

FIGS. 3A and 3B are schematic diagrams showing other embodiments of the invention, in which the flexible lighting elements are provided at different positions; and

FIG. 4 is a schematic diagram showing the flexible lighting element according to an embodiment of the invention.

### DETAILED DESCRIPTIONS OF THE PREFERRED EMBODIMENTS

The present invention will be apparent from the following detailed description, which proceeds with reference to the accompanying drawings, wherein the same references relate to the same elements.

The lighting device for a housing according to the preferred embodiments of the invention will be described with reference to the relevant drawings.

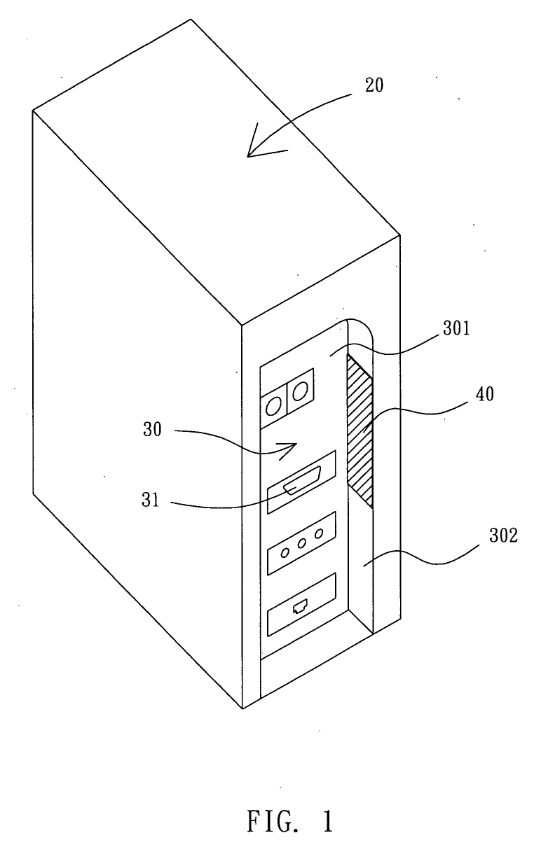

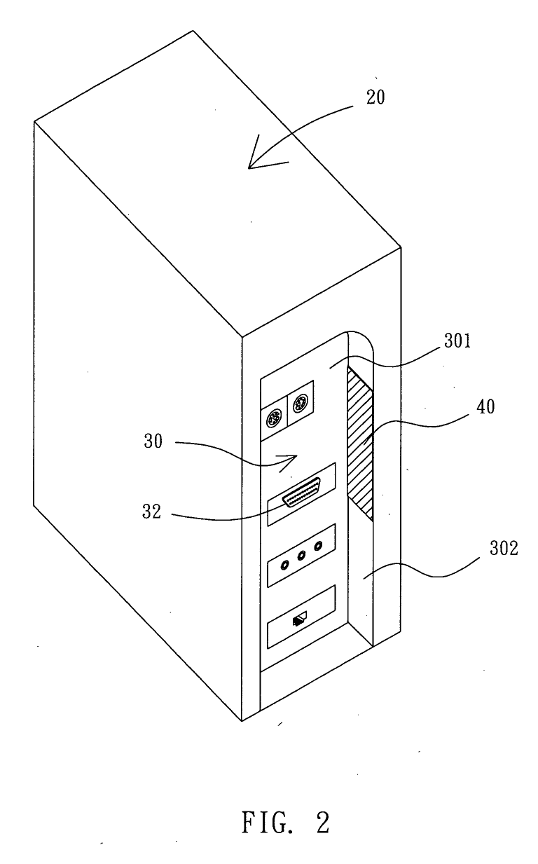

Please refer to FIG. 1, the lighting device for a housing according to the preferred embodiment of the invention is provided at a concave portion 30 of a housing 20. The concave portion 30 has a surface and a sidewall, and the surface 301 has an opening 31 for the mounting of a connection port 32 (as shown in FIG. 2). The connection port 32 is capable of connecting with other peripheral devices such as a printer or a speaker.

Please refer to FIG. 2, the lighting device for a housing according to the preferred embodiment of the invention includes a flexible lighting element 40. The flexible lighting element 40 is provided at any position of the sidewall 302 of the concave portion, so that a user can identify the connection port 32 easily even in dark environment. The flexible lighting element 40 may be a luminescence sheet or an organic electroluminescent film. In the present embodiment, the flexible lighting element 40 is the luminescence sheet.

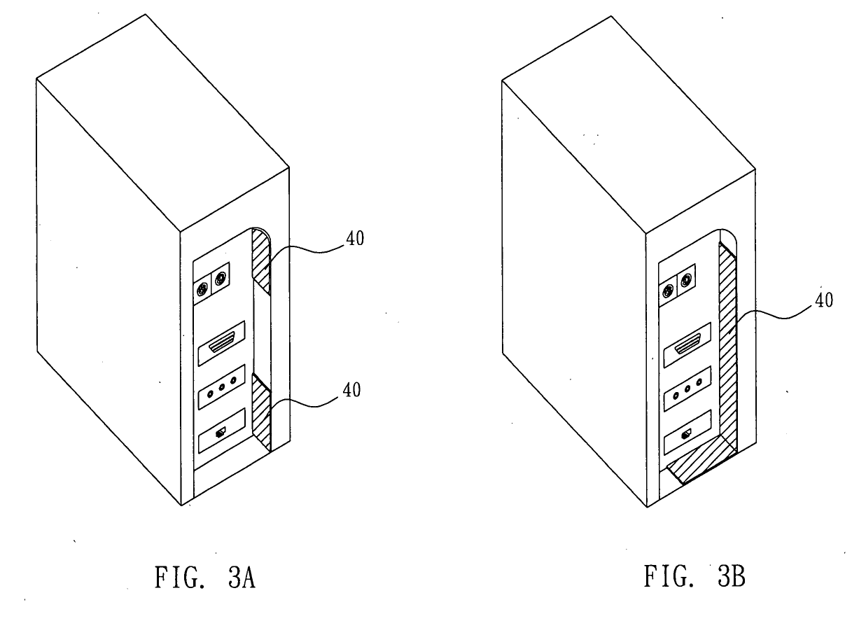

In the present embodiment, the opening 31 of the concave portion 30 is provided with the connection port 32, and the flexible lighting element 40 is provided at the sidewall 302 of the concave portion 30, therefore the user can examine the connection port 32 easily without the light being blocked since the flexible lighting element 40 provides sidelight to the connection port 32 from the sidewall 302. Furthermore, due to the thinner thickness, the flexible lighting element 40 can be provided on the sidewall 302 of the concave portion 30 without conflicting with the connection port 32. In other embodiments, a plurality of flexible lighting element 40 (as shown in FIG. 3A) or a larger flexible lighting element 40 (as shown in FIG. 3B) can be provided on the sidewall 302 of the concave portion 30 to fulfill the needs of different users. In other words, the shape, number and size of the flexible lighting element 40 can be adjusted in view of actual needs without limitation.

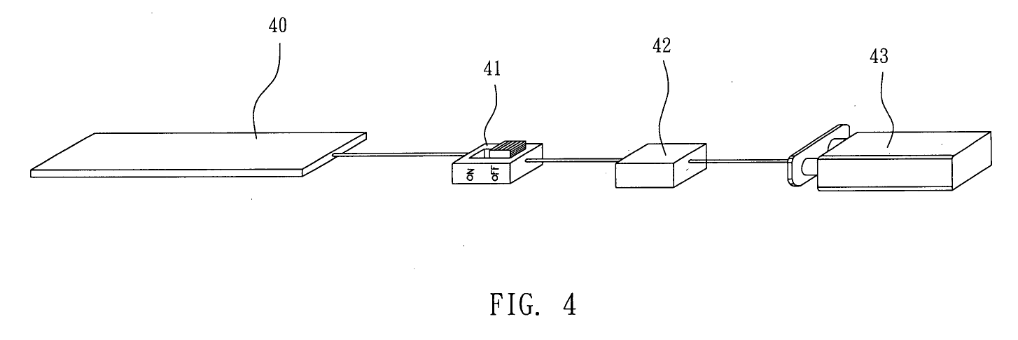

Please refer to FIG. 4 again, in the present embodiment, the flexible lighting element 40 can further include a switch 41, a rectifier 42, and a power module 43. The switch 41 is electrically connected with the flexible lighting element 40 to switch the on/off mode of the flexible lighting element 40.

The rectifier 42 electrically connected the switch 41 with the power module 43 to rectify the power for the flexible lighting element 40. The power module 43 may be DC power module, which may be an independent DC power module (such as a battery) or a DC power source provided by the computer. With an independent DC power module, the flexible lighting element 40 can function without turning on the computer. The power module 43 may also be an AC power module, which power is supplied by public power facility and can function without turning on the computer.

In the present embodiment, the switch 41 can be provided at any position, such as at the front of the computer or on the desk, to facilitate the switch operation of the user. The type of the switch 41 may be different from the power switch of the computer for differentiation purpose, so that the user can find and identify the switch 41 without sufficient light. Furthermore, the user may change the position of the flexible lighting element 40 to satisfy his or her needs.

To sum up, the lighting device for a housing according to the embodiment has the following advantages:

1. The lighting device for the housing is sited on the sidewall of the concave portion of the housing to provide light to the connection port. Therefore, light is provided from the sidewall, which can reduce the phenomenon of back-lighted and provide better light effect.

2. The shape of the lighting device can vary in view of the shape of the concave portion. By designing the pattern of the flexible lighting element, the aesthetic effect can be enhanced with low cost.

3. The lighting device may function without turning on the computer using an independent power source, which further facilitates the operation of the user.

4. The lighting device may be mounted at any position of the conventional computer housing. The compute r housing does not need a special design, which is convenient for a user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A lighting device of a housing having a concave portion, the concave portion having a surface and a sidewall, the surface having an opening for a connection port, the lighting device comprising:
a flexible lighting element sited on the sidewall of the concave portion.

2. The lighting device according to claim 1, further comprising:
a power module electrically connected with the flexible lighting element.

3. The lighting device according to claim 2, wherein the power module is a DC power module.

4. The lighting device according to claim 2, wherein the power module is an AC power module.

5. The lighting device according to claim 2, further comprising:
a rectifier electrically connected the power module with the flexible lighting element respectively, wherein the rectifier changes a power type output from the power module to another power type for use of the flexible lighting element.

6. The lighting device according to claim 5, further comprising:
a switch electrically connected with the flexible lighting element and the rectifier respectively for switching the flexible lighting element to an on or off status.

7. The lighting device according to claim 1, further comprising:
a switch electrically connected with the flexible lighting element for switching the flexible lighting element to an on or off status.

8. The lighting device according to claim 1, wherein the flexible lighting element is a luminescence sheet.

9. The lighting device according to claim 1, wherein the flexible lighting element is an organic electroluminescent film.

10. A lighting device of a housing having a concave portion, the concave portion having a surface and a sidewall, the surface having an opening for a connection port, the lighting device comprising:
a flexible lighting element sited on the sidewall of the concave portion for lighting the connection port.

11. The lighting device according to claim 10, further comprising:
a power module electrically connected with the flexible lighting element.

12. The lighting device according to claim 11, wherein the power module is a DC power module.

13. The lighting device according to claim 11, wherein the power module is an AC power module.

14. The lighting device according to claim 11, further comprising:
a rectifier electrically connected the power module with the flexible lighting element respectively, wherein the rectifier changes a power type output from the power module to another power type for use of the flexible lighting element.

15. The lighting device according to claim 14, further comprising:
a switch electrically connected with the flexible lighting element and the rectifier respectively for switching the flexible lighting element to an on or off status.

16. The lighting device according to claim 10, further comprising:
a switch electrically connected with the flexible lighting element for switching the flexible lighting element to an on or off status.

17. The lighting device according to claim 10, wherein the flexible lighting element is a luminescence sheet.

18. The lighting device according to claim 10, wherein the flexible lighting element is an organic electroluminescent film.

19. A lighting device of a housing having a concave portion, the concave portion having a surface and a sidewall, the surface having an opening for a connection port, the lighting device comprising:
a luminescence sheet provided on the sidewall of the concave portion for lighting the connection port.

20. The lighting device according to claim 19, further comprising:
a power module electrically connected with the luminescence sheet.

21. The lighting device according to claim 20, wherein the power module is a DC power module.

22. The lighting device according to claim 20, wherein the power module is an AC power module.

23. The lighting device according to claim 20, further comprising:
a rectifier electrically connected with the power module and the luminescence sheet respectively, wherein the rectifier generates another power type for use of the flexible lighting element according to a power type output from the power module.

24. The lighting device according to claim 23, further comprising:
a switch electrically connected with the luminescence sheet and the rectifier respectively for switching the luminescence sheet to an on or off status.

25. The lighting device according to claim 19, further comprising:
a switch electrically connected with the luminescence sheet for switching the luminescence sheet to an on or off status.
